(19) United States
(12) Patent Application Publication
(10) Pub. No.: US 2024/0062440 A1
(43) Pub. Date: Feb. 22, 2024

(54) MARKET DISPLAY ANALYSIS METHOD, SYSTEM, DEVICE AND MEDIUM

(71) Applicant: Zhaoqi HU, Tokyo (JP)

(72) Inventor: Zhaoqi HU, Tokyo (JP)

(21) Appl. No.: 18/228,287

(22) Filed: Jul. 31, 2023

(30) Foreign Application Priority Data
Aug. 18, 2022 (JP) 2022-130677

(51) Int. Cl. G06T 11/20

(52) U.S. Cl. CPC G06T 11/206

(57) ABSTRACT

The present invention provides an unprecedented, intuitive, and easy-to-understand market price display method, system, device, and medium for displaying and analyzing quotes. In a predetermined period, the opening price, the closing price, the lowest price, and the highest price are used to calculate the difference between the lowest price and the closing price as the positive quantity P, and the difference between the highest price and the closing price as the negative quantity N. A mid-value calculating unit calculates a mid-value M by subtracting the negative quantity N from the positive quantity P; and plotting unit plots the mid-value M. Also, the positive force PF, the negative force NF, the positive accumulation PA, the negative accumulation NA and the specific point SP are useful for decision making.

### CROSS REFERENCE TO RELATED APPLICATION

This U.S. Non-Provisional Patent application claims priority to Japanese Patent Application JP2022-130677, filed on Aug. 18, 2022, now Japanese Patent JP720493, issued on Feb. 2, 2023.

### FIELD

The present invention relates to a market display system. More specifically, it involves a market display analysis method, system, device, and medium that utilize the candlestick charting technique (Sakata Method) and the concept of trend analysis.

### BACKGROUND

In order to display the market trends of stocks, futures, and other securities, the Sakata Method (commonly known as candlestick chart) has been widely used. It is a type of bar chart that represents the opening and closing prices of a given period (e.g., 1 day) using thick lines. If the closing price is higher than the opening price, it is depicted as a white candlestick (bullish). If the closing price is lower than the opening price, it is depicted as a black candlestick (bearish). Additionally, if there are values within the white candlestick that are lower than the opening price, or values within the black candlestick that are lower than the closing price, a single line called the lower shadow is drawn downward. Similarly, if there are values within the black candlestick that are higher than the opening price, or values within the white candlestick that are higher than the closing price, a line called the upper shadow is drawn upward.

The charting is referred to as daily chart when the time period is set to one day, and as hourly chart when the time period is set to one hour. There are also shorter time period divisions such as 15-minute chart and 1-minute chart.

Usually, the opening price, the closing price, the highest price, and the lowest price are collectively referred to as the four values or prices.

There are various chart analyses that apply the Sakata Method for market visualization.

In the patent document published in the Official Gazette of Japan under Patent Publication No. 2012-104067, a chart analysis program is disclosed, which enables a computing device to perform the following functions:

A market information acquisition unit: It acquires market information for each time period.

A chart analysis starting point information acquisition unit: It obtains chart analysis starting point information, which determines the starting point for conducting chart analysis.

A chart analysis time information acquisition unit: It obtains chart analysis time information, which determines the analysis time starting from the starting point of chart analysis.

An analysis chart depiction period information acquisition unit: It acquires analysis chart depiction period information used to specify the period to be depicted on the display unit.

A highest price information extraction unit: Based on the acquired chart analysis starting point information and chart analysis time information, it extracts the highest price information of the market within the specified analysis time.

A lowest price information extraction unit: Based on the acquired chart analysis starting point information and chart analysis time information, it extracts the lowest price information of the market within the specified analysis time.

A highest and lowest price information output unit: Based on the acquired analysis chart depiction period information, it displays the analyzed chart by presenting the extracted highest and lowest price information of the market within the specified depiction period.

In the patent document published in the Official Gazette of Japan under Patent Publication No. 2006-072923, a candlestick chart is described where vertical bar-shaped upper shadows and lower shadows are placed above and below the central area of a rectangular body. By arranging the candlestick lines, with the body color white for bullish (rising) candles and black for bearish (falling) candles, in chronological order, it becomes possible to observe the opening price, the closing price, the highest price, and the lowest price of the market. The bending of the top ends of the upper and lower shadows to the left or right at right angles represents the temporal relationship of the highest and lowest prices.

The traditional Japanese candlestick chart, known as “Sakata Candle K-line,” has always been plotted based on price changes. However, since different stocks have different price levels, it becomes challenging to express the buying and selling strength within the chart. Therefore, in this application, the concept of positive and negative quantity is introduced to quantify the chart. This allows for AI-based data analysis and statistical interpretation of historical trends, facilitating the identification of unique characteristics in the price movements of individual stocks.

### DETAILED DESCRIPTION OF THE INVENTION

The Problem that the Invention Solves

In the existing method of displaying quotes, it is not possible to intuitively grasp the quotes of multiple periods, which makes it difficult to analyze stock movements.

The purpose of the present invention is to provide an unprecedentedly intuitive and easy-to-understand method, system, device, and medium for displaying and analyzing quotes.

### Technical Solutions for Solving the Problem

### A Stock Market Analysis Method

A stock market analysis method for displaying and analyzing market trends includes the following steps:
S1: Obtaining the opening price, the closing price, the highest price, and the lowest price of stocks for several predetermined periods.
S2: Calculating the positive quantity P (the difference between the lowest price and the closing price), the negative quantity N (the difference between the highest price and the closing price), and the mid-value M (the difference between the positive quantity P and the negative quantity N) for each predetermined period.
S3: Plotting tables, line charts, or bar charts of the positive quantity P, the negative quantity N, and/or the median value M in a time series, starting from the opening price of the first predetermined period.
S4: Identifying the specific points SP on the line chart and issuing notifications, alerts, or decisions.

In S2 of some embodiment, the absolute value of the sum of the positive quantity P and the mid-value M for a plurality of predetermined periods is also calculated to obtain the positive force PF, or the absolute value of the sum of the negative quantity N and the mid-value M for a plurality of predetermined periods is calculated to obtain the negative force NF.

In some embodiment of S2, the positive force PF and negative force NF for a plurality of predetermined periods are added together to calculate the positive accumulation PA and the negative accumulation NA.

In S2 of some embodiment, a table, a line graph, or a bar graph of the positive accumulation PA and/or the negative accumulation NA are plotted for a number of predetermined periods in a time series.

In S3 of some embodiment, the quotes based on the Sakata method are displayed side by side with the line graph or the bar graph.

In S4 of some embodiment, the characteristic specific point SP scenario includes one or a combination of being: (a) the specific point SP1, when the mid-value M=0, and (b) the specific point SP2, when the difference between the mid-value M and the negative quantity N of the stock price is within a predetermined threshold.

### A Stock Market Analysis System

A stock market analysis system includes the following components:

A market information acquisition unit: for obtaining the opening price, closing price, highest price, and lowest price of stocks for several predetermined periods.

A processing unit: for calculating the positive quantity P, the negative quantity N, and the mid-value M for each predetermined period.

A plotting unit: for plotting tables, line charts, or bar charts of positive quantity P, negative quantity N, and/or mid-value M in a time series.

An analysis unit: for identifying specific points SP on the charts and issuing notifications, alerts, or decisions.

In some embodiment, the processing unit includes a positive and negative quantity calculation unit that calculates the positive quantity P as the difference between the lowest price and the closing price for each predetermined period, and the negative quantity N as the difference between the highest price and the closing price.

In some embodiment, the processing unit includes a mid-value calculation unit that calculates the mid-value M by subtracting the negative quantity N from the positive quantity P. The plotting unit plots the calculated mid-value M.

In some embodiment, the computational processing unit further includes a positive and negative force calculation unit that calculates the positive force PF by adding the absolute value of the sum of the stock positive quantities P and the mid-value M for the predetermined periods, and calculates the negative force NF by adding the absolute value of the sum of the stock negative quantities N and the mid-value M. The displaying unit displays the positive force PF and the negative force NF calculated by the positive and negative force calculation unit.

In some embodiment, the computational processing unit also includes a positive and negative accumulation calculation unit that adds the positive force PF and the negative force NF for multiple predetermined periods to calculate the positive accumulation PA and the negative accumulation NA. The plotting unit displays the positive accumulation PA and the negative accumulation NA calculated by the positive and negative accumulation calculation unit.

In some embodiment, the plotting unit plots the positive quantity P and the negative quantity N, and/or the mid-value M for a plurality of the predetermined periods side-by-side with the Sakata-based candlestick display, respectively, as a time series.

In some embodiments, there is also a storage unit that includes a market information storage unit for storing information obtained by the market information acquisition unit, and/or an output value storage unit for storing values calculated by the computational processing unit.

In some embodiment, the analysis unit identifies specific point SP1, when the mid-value M=0 and/or the specific point SP2, when a difference between the mid-value M and the stock negative quantity N is within a predetermined threshold.

In another embodiment, a market display analysis device includes a processor and a memory, where the processor executes a market display analysis program stored in the memory, to display the results of the market display analysis method accordingly.

In yet another embodiment, a medium stores one or more programs that can be executed by one or more processors to implement any of the market display analysis method accordingly.

The stock market analysis system of this invention provides an intuitive and easily understandable display of market trends by calculating positive quantity and negative quantify of stock market prices across multiple periods and presenting them in charts. Based on the specific points identified in the displayed trends, users can quickly analyze market movements and make timely decisions.

The market quotes display system of the present invention provides users with intuitive and easily understandable market displays by calculating stock positive quantities and stock negative quantities for multiple periods and outputting them as charts. Based on the specific points on the market display, the system enables rapid analysis of market trends, facilitating timely decision-making.

### BRIEF DESCRIPTION OF THE DRAWINGS

FIG. 1: Comprehensive structure diagram of the market display system (pattern obtained from a security company).

FIG. 2: Comprehensive structure diagram of the market display system (pattern obtained from a stock exchange).

FIG. 3: Structure diagram of the market information system.

FIG. 4: Pattern with positive quantity and negative quantity (bullish candlestick pattern with upper and lower shadows).

FIG. 5: Pattern with positive quantity and negative quantity (bullish candlestick pattern with upper shadow).

FIG. 6: Pattern with positive quantity and negative quantity (bearish candlestick pattern with upper and lower shadows).

FIG. 7: Pattern with positive quantity and negative quantity (bearish candlestick pattern with lower shadow).

FIG. 8: Pattern with positive quantity and negative quantity (candlestick pattern with upper and lower shadows).

FIG. 9: Pattern with zero negative quantity (bullish candlestick pattern with lower shadow).

FIG. 10: Pattern with zero negative quantity (bullish candlestick pattern without shadows).

FIG. 11: Pattern with zero negative quantity (hammer candlestick pattern with lower shadow).

FIG. 12: Pattern with zero positive quantity (bearish candlestick pattern with upper shadow).

FIG. 13: Pattern with zero positive quantity (bearish candlestick pattern without shadows).

FIG. 14: Pattern with zero positive quantity (hanging man candlestick pattern with upper shadow).

FIG. 15: Example output of positive quantity, negative quantity, and mid-values (table).

FIG. 16: Example output of positive quantity, negative quantity, and mid-values (line chart).

FIG. 17: Example output of positive quantity, negative quantity, and mid-values (bar chart and line chart).

FIG. 18: Example demonstrating simultaneous display of Sakata Method (candlestick), positive quantity, negative quantity, and mid-values (bar chart and line chart).

FIG. 19: Example demonstrating simultaneous display of Sakata Method (candlestick), positive quantity, negative quantity, and mid-values (line chart).

FIG. 20: Example output of positive force PF and negative force PF (line chart).

FIG. 21: Flowchart of the market quotes display system.

Description of the numbers and letters that correspond to various parts in the drawings:
1 Market display system
11 Computation processing device
111 Market information acquisition unit
112 Positive and negative quantity calculation unit
113 Mid-value calculation unit
114 Positive and negative force calculation unit
115 Positive and negative accumulation calculation unit
116 Plotting unit
12 Storage unit
121 Market information storage unit
122 Calculation value storage unit
2 User terminal
3 Security company server
4 Stock exchange server
O Opening price
C Closing price
H Highest price
L Lowest price
P Positive quantity
N Negative quantity
PF Positive force
NF Negative force
PA Positive accumulation
NA Negative accumulation
M Mid-value
SP1 First specific point
SP2 Second specific point
A Market quotes display administrator
B End User
C Security company
D Security exchange

### Example of Implementation Method

An example implementation of the market display system is illustrated with the accompanying diagrams. This implementation example is based on a market display system that calculates indicators of price changes using multiple values within a predetermined period. The system uses the opening price of the period as the initial value, the closing price of the period as the final value, the lowest price within the period as the minimum value, and the highest price within the period as the maximum value.

### The Market Display System

The market display system includes the following components:

A positive and negative quantity calculation unit: This unit calculates the positive quantity P by subtracting the closing price from the lowest price within each predetermined period, and the negative quantity N by subtracting the closing price from the highest price within the period.

A plotting unit: This unit plots the positive quantity P and/or the negative quantity N calculated by the positive and negative quantity calculation unit.

An analysis unit: This unit identifies specific points (SP) on the chart and provides notifications, warnings, or decision-making assistance.

A mid-value calculation unit: This unit calculates the mid-value M by subtracting the negative quantity N from the positive quantity P. The plotting unit then plots the mid-value calculated by this unit.

A plotting unit: This unit plots the positive quantity P, the negative quantity N, and/or the mid-value M of multiple predetermined periods as time series charts.

A positive and negative force calculation unit: This unit calculates the positive force PF by adding the absolute values of the positive quantity P and the mid-value M for multiple predetermined periods, and the negative force NF by adding the absolute values of the negative quantity N and the mid-value M for multiple predetermined periods. The plotting unit then plots the calculated positive force and negative force.

A positive and negative accumulation unit: This unit adds up the positive forces PF and the negative forces NF for a predetermined period to calculate the positive accumulation PA and the negative accumulation NA. The displaying unit display the positive accumulation PA and the negative accumulation NA calculated by the positive and negative accumulation unit.

A storage unit: This unit includes a market information storage section for storing information obtained by the market information acquisition unit and/or a calculated value storage section for storing the values calculated by the computation processing unit.

### System Structure

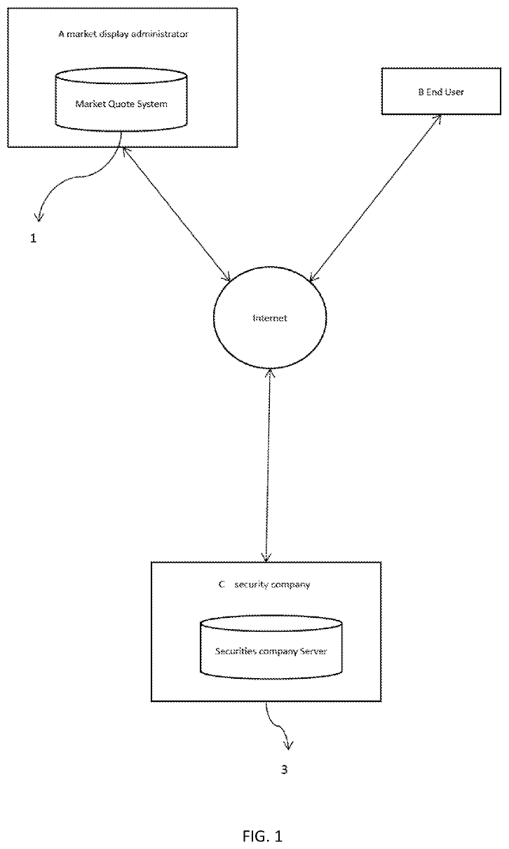

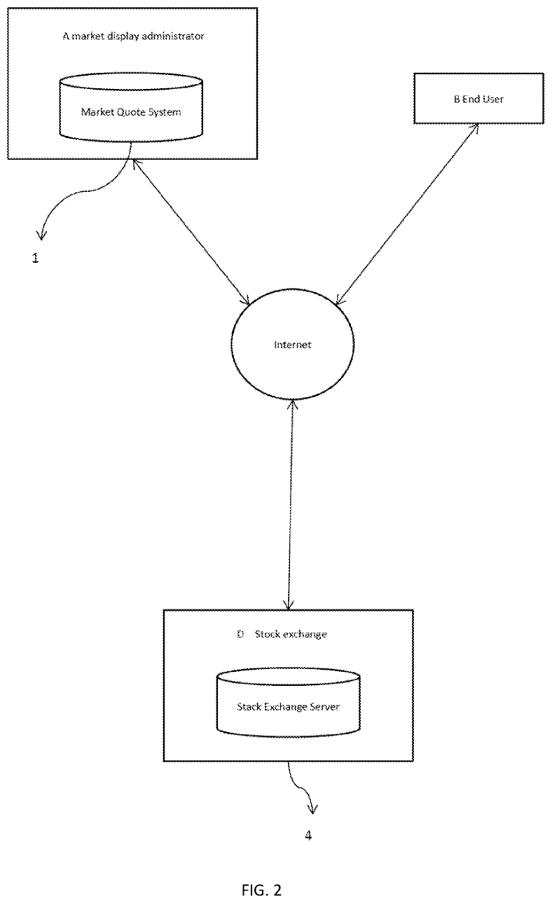

The present invention is based on the calculation of the positive quantity P by subtracting the lowest price from the closing price, and the calculation of the negative quantity N by subtracting the highest price from the closing price. These values are then plotted. As shown in FIGS. 1 and 2, the market display system 1 consists of a market display administrator A, an end user B, and a securities company C or a stock exchange D, which communicate with each other via the internet. It is also possible for the market display administrator A to be the end user B. Additionally, the security company C can be the market display administrator A. In other words, the security company itself uses the market display system 1 (assembling it into the existing system of the company) to provide market display as an indicator to customers, among others.

### Structure of Market Display Server

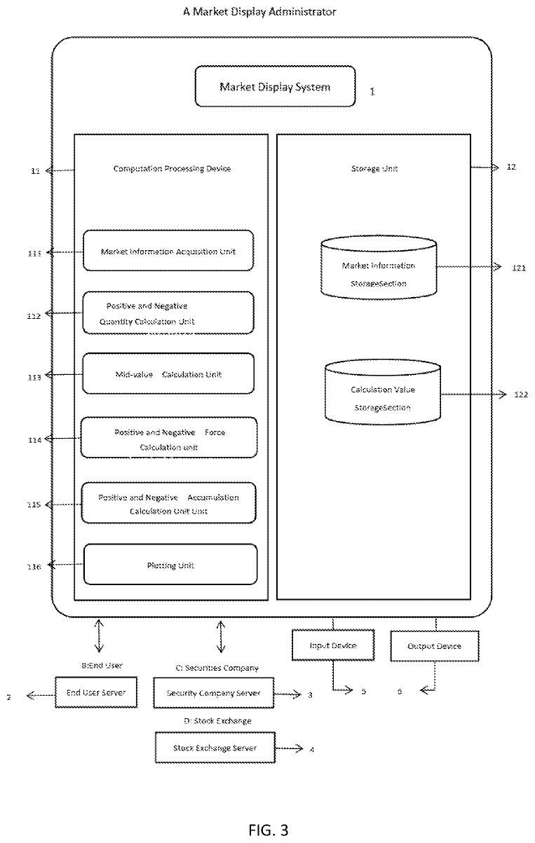

As shown in FIG. 3, the market display system 1, managed by the market display administrator A, consists of a computation processing device 11 and a storage unit 12. The computation processing device 11 includes a market information acquisition unit 111, a positive and negative quantity calculation unit 112, a mid-value calculation unit 113, a positive and negative force calculation unit 114, a positive and negative accumulation calculation unit 115, and a plotting unit 116.

The storage unit 12 includes a market information storage section 121 and a calculated value storage section 122.

The market information acquisition unit 111 retrieves market information such as stock names or the four values from the securities company server 3 or the exchange server 4 of the securities company C or the stock exchange D and stores it in the market information storage section 121. The provider of market information can be the securities company C, the stock exchange D, or both.

In the case of obtaining only from stock company C, it becomes a structure without stock exchange D (FIG. 1), and in the case of obtaining only from stock exchange D, it becomes a structure without stock company C (FIG. 2).

The positive and negative quantity calculation unit 112 calculates the positive quantity P and the negative quantity N based on the market information stored in the market information storage section 121, and stores them in the calculation value storage section 122.

The mid-value calculation unit 113 calculates the mid-value M based on the positive quantity P and the negative quantity N stored in the calculated value storage section 122.

The mid-value M is calculated based on the positive quantity P and the negative quantity N stored in the output value store 122.

The positive and negative force calculation unit 114 calculates the positive force PF and the negative force NF based on the positive volume P, the negative volume N, and the mid-value M stored in the output value storage section 122, and stores the positive force PF and the negative force NF in the output value storage section 122.

The positive and negative accumulation calculation unit 115 calculates the positive accumulation PA and the negative accumulation NA based on the positive force PF and the negative force NF stored in the calculation value storage section 122, and stores the positive accumulation PA and the negative accumulation NA in the calculation value storage section 122.

The plotting unit 116 display the positive quantity P, the negative quantity N, and the mid-value M stored in the output value storage section 122.

The positive quantity P, the negative quantity N, and the mid-value M, as well as the positive accumulation PA and the negative accumulation NA, are stored in the output value storage section 122.

### Calculation of Positive Quantity and Negative Quantity

In some embodiments, the following patterns are shown for calculating the positive quantity P and the negative quantity N based on four values.

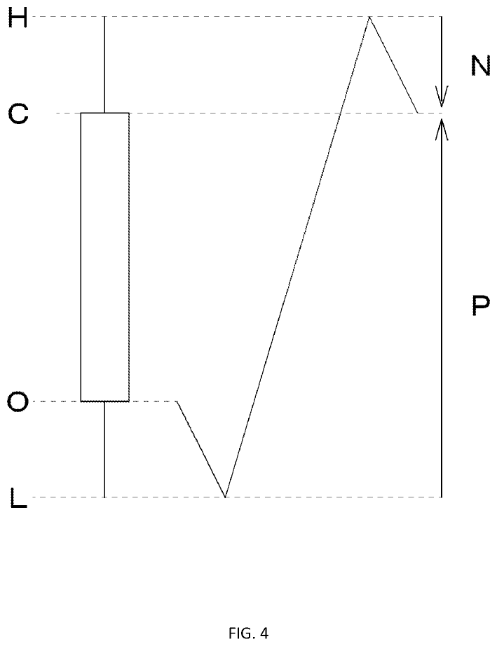

FIGS. 4, 5, 6, 7, and 8 depict the market trends for five patterns where both the positive quantity P and the negative quantity N are calculated.

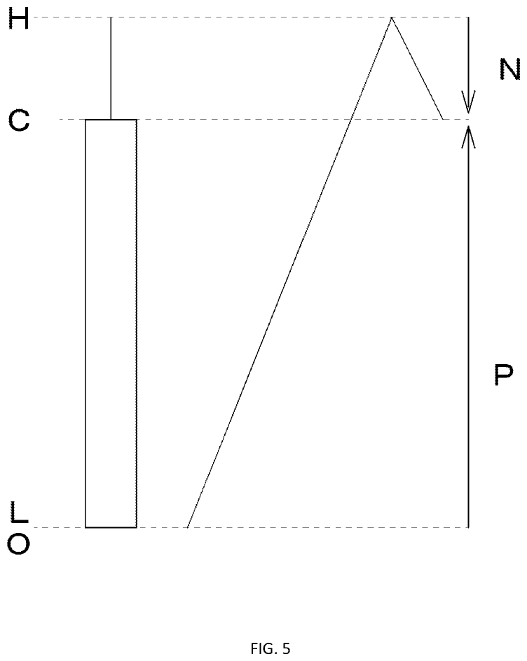

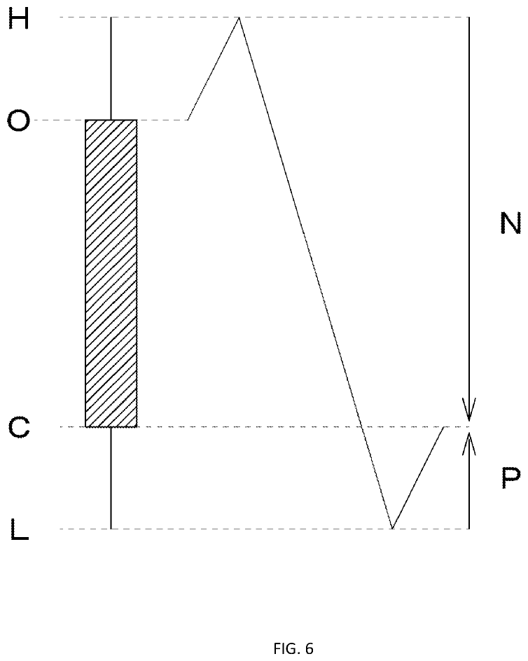

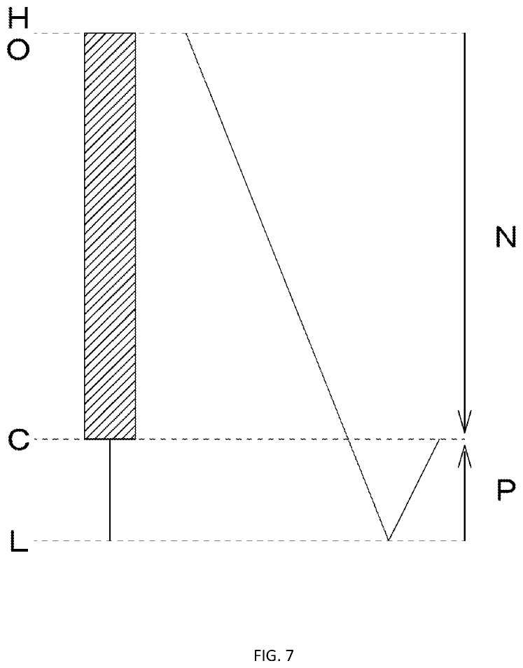

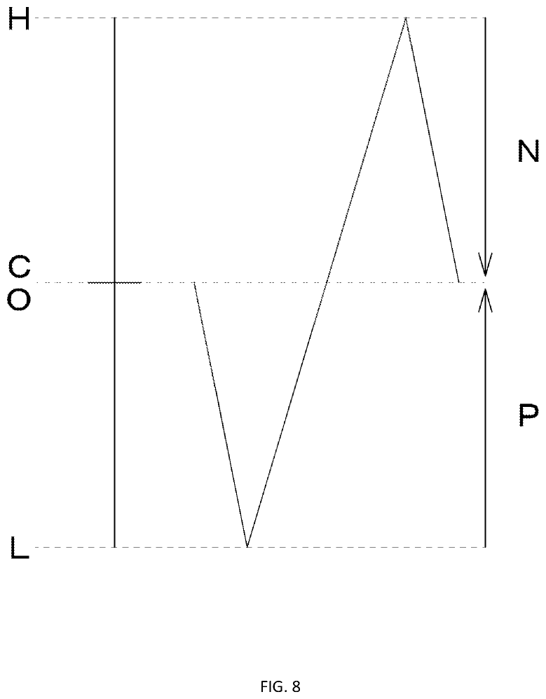

FIG. 4 represents a bullish candlestick with upper and lower shadows. FIG. 5 represents a bullish candlestick with only an upper shadow. FIG. 6 represents a bearish candlestick with upper and lower shadows. FIG. 7 represents a bearish candlestick with only a lower shadow. FIG. 8 represents a candlestick with upper and lower shadows forming a cross.

In the cases of FIGS. 4, 6, and 8, the difference between the lowest price L and the closing price C for the period is calculated as the positive quantity P, and the difference between the highest price H and the closing price C for the period is calculated as the negative quantity N.

In the case of FIG. 5, since the opening price O is the same as the lowest price L for the period, the difference between the opening price O (or the lowest price L) and the closing price C is calculated as the positive quantity P, and the difference between the highest price H and the closing price C is calculated as the negative quantity N.

In the case of FIG. 7, the difference between the lowest price L and the closing price C for the period is calculated as the positive quantity P, and since the opening price O is the same as the highest price H for the period, the difference between the opening price O (or the highest price H) and the closing price C is calculated as the negative quantity N.

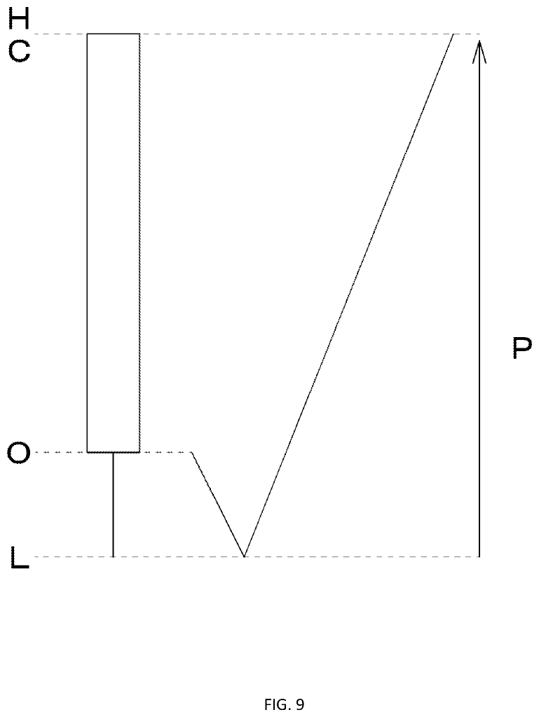

FIGS. 9, 10, and 11 depict market trends for three patterns where only the positive quantity P is calculated, in other words, when the negative quantity N is zero.

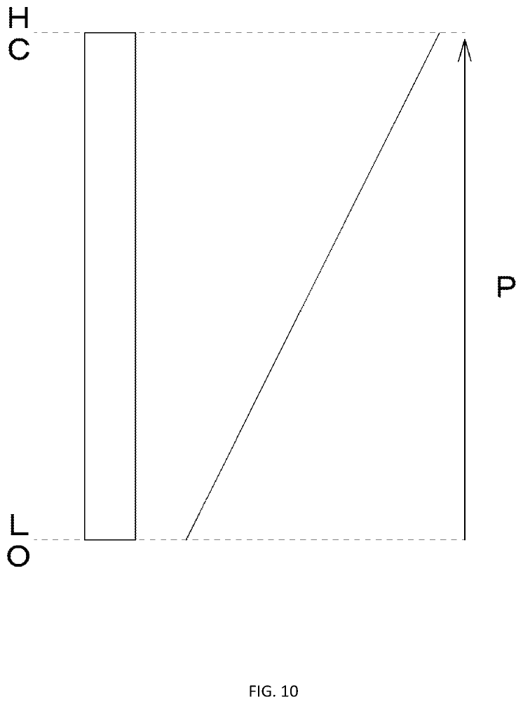

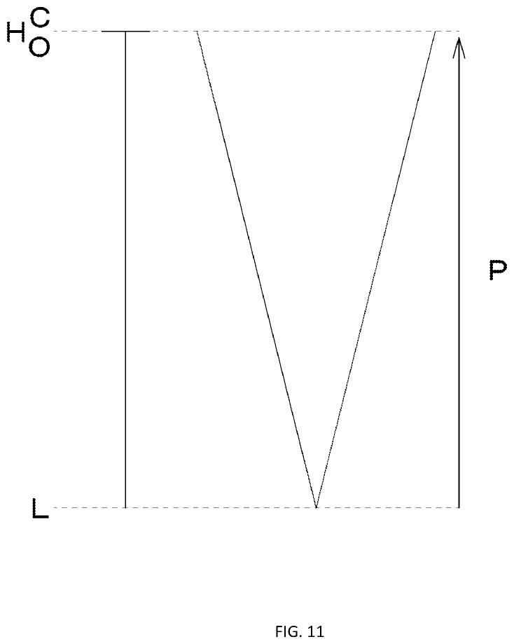

FIG. 9 represents a candlestick with only a lower shadow. FIG. 10 represents a candlestick with no shadow. FIG. 11 represents a candlestick with only a lower shadow forming a “T” shape.

In the cases of FIGS. 9 and 11, the difference between the lowest price L and the closing price C for the period is calculated as the positive quantity P. In the case of FIG. 10, the difference between the opening price O (or the lowest price L) and the closing price C for the period is calculated as the positive quantity P.

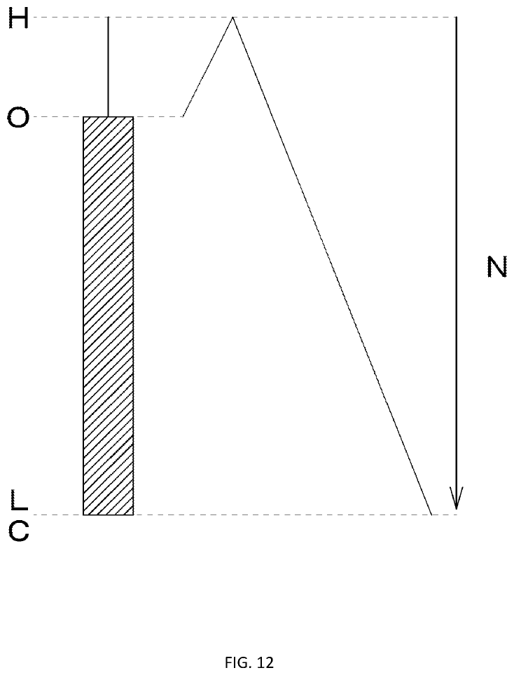

FIGS. 12, 13, and 14 illustrate the market trends of three patterns based solely on the calculation of negative quantity, N. In other words, these are patterns where the positive quantity, P, is 0.

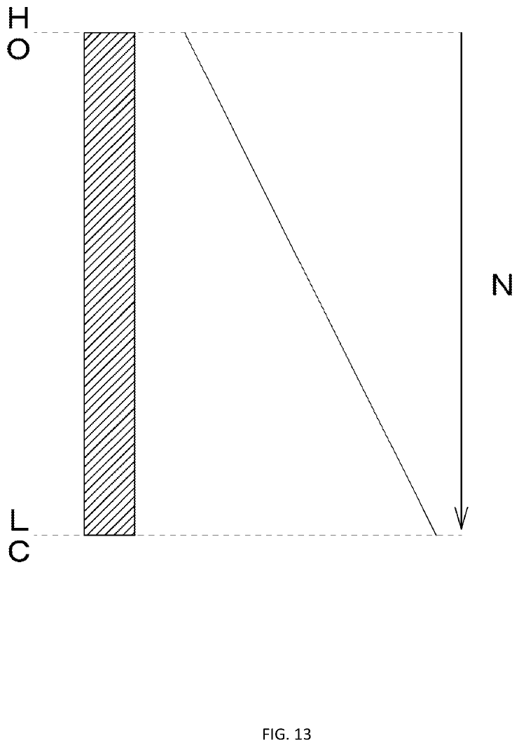

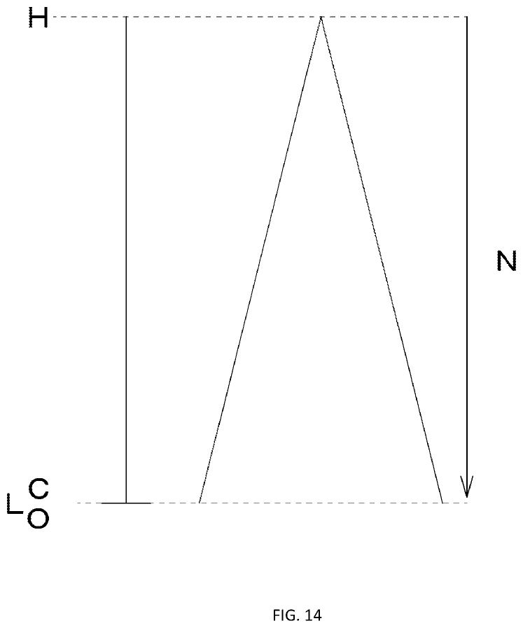

FIG. 12 represents a bearish candlestick with only upper shadow. FIG. 13 represents a bearish candlestick with no shadow. FIG. 14 represents a bearish candlestick with only upper shadow and a reversed hammer pattern.

In the cases of FIG. 12 and FIG. 14, the difference between the highest price, H, and the closing price, C, during the period is calculated as the negative quantity, N. In the case of FIG. 13, the difference between the opening price, O (which is equal to the highest price, H, during the period), and the closing price, C, is calculated as the negative quantity, N.

There are no specific restrictions on calculating positive and negative quantities in the calculation unit 112. It can adopt specifications that calculate both positive and negative quantities in all cases, including cases where the result is 0. If the lowest price, L, during the period is the same as the closing price, C, the positive quantity, P, is 0, so it is not calculated. Similarly, if the highest price, H, during the period is the same as the closing price, C, the negative quantity, N, is 0, so it is not calculated. In such cases, the value of 0 is stored as the result in the calculation storage unit 122.

### Calculation of Mid-Values

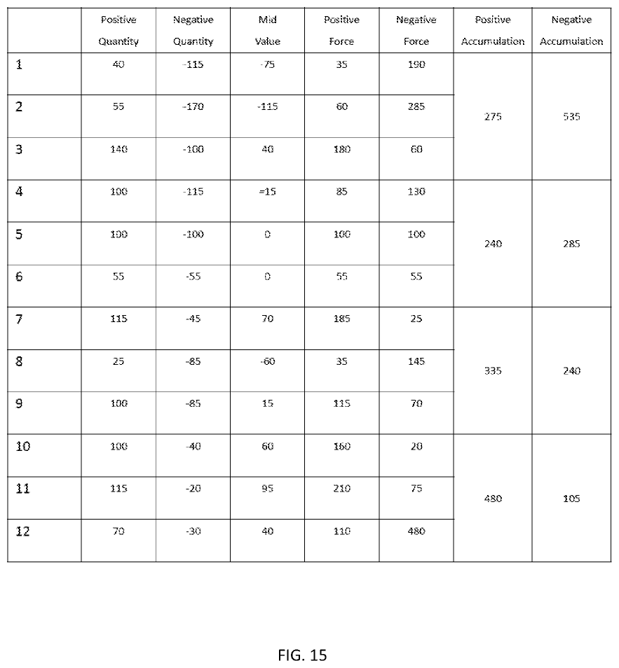

FIG. 15 illustrates an example of the state in which the positive price P and negative price N, calculated by the positive/negative quantity calculation unit 112, are stored in the calculation value storage section 122.

The mid-value calculation unit 113 calculates the mid-value M by adding the positive quantity P and the negative quantity N. For example, in period 1 (row 1), the positive quantity P is 40, the negative quantity N is −115, so the calculated mid-value M is −75 (=40−115). In period 10 (row 10), the positive quantity P is 100, the negative quantity N is −40, so the calculated mid-value M is 60 (=100−40).

The calculated mid-value M, the positive quantity P, and the negative quantity N are also stored in the calculation value storage section 122.

Furthermore, they are calculated and stored for multiple periods. In the illustrated example, calculation and storage are performed for periods 1 to 12 (e.g., 12 days).

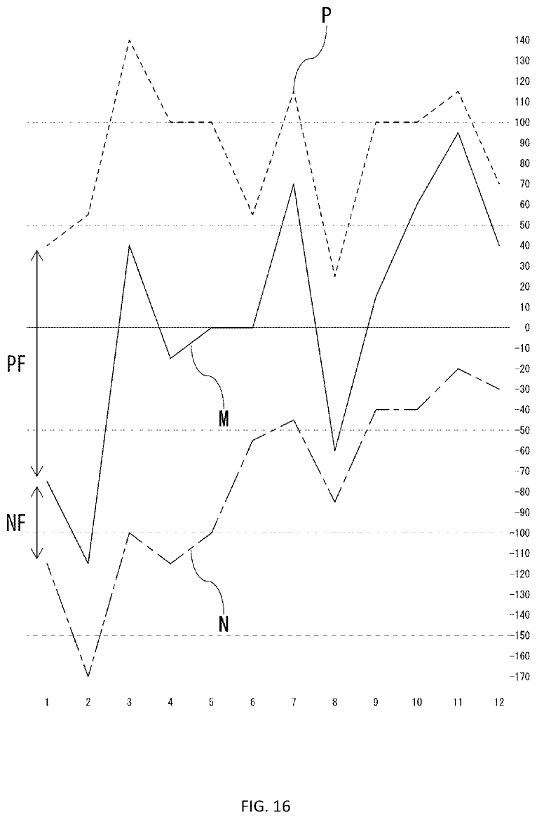

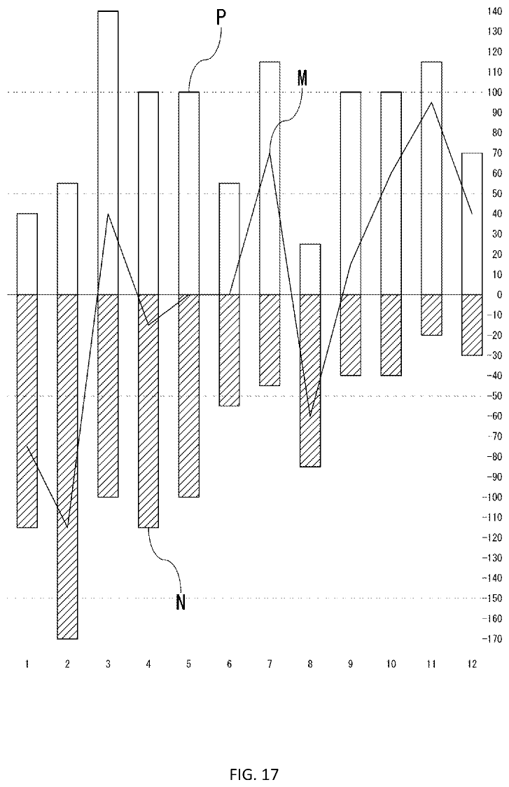

FIG. 16 shows an example where the positive quantity P, the negative quantity N, and the mid-value M are plotted as line graphs. As shown in FIG. 17, the positive quantity P and the negative quantity N can also be represented as bar graphs. In the charts, scales can be marked at equal intervals for easy observation. In the illustrated example, scale lines are marked at intervals of 10 and 50 Japanese Yen.

In this system, the positive quantity P can be understood as the force of an upward market trend, and the negative quantity N can be understood as the force of a downward market trend. In the illustrated example, it can be observed that the force of an upward market trend is exerted in periods 3, 7, and 11, while the force of a downward market trend is exerted in periods 2 and 8.

Stocks have buyers and sellers, and if no transaction occurs, no values will be assigned or appear in the charts. By calculating and plotting the mid-value M, the visual representation of upward and downward forces become apparent, thus allowing for an understanding of market trends where transactions did not occur.

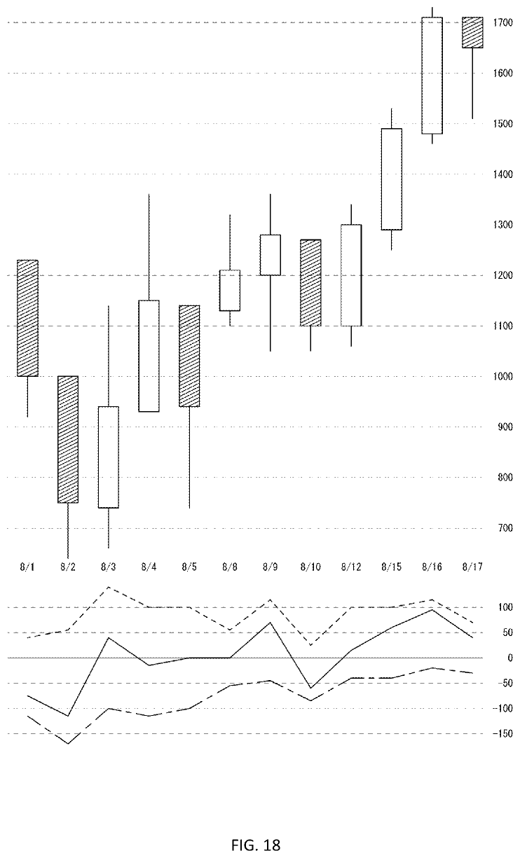

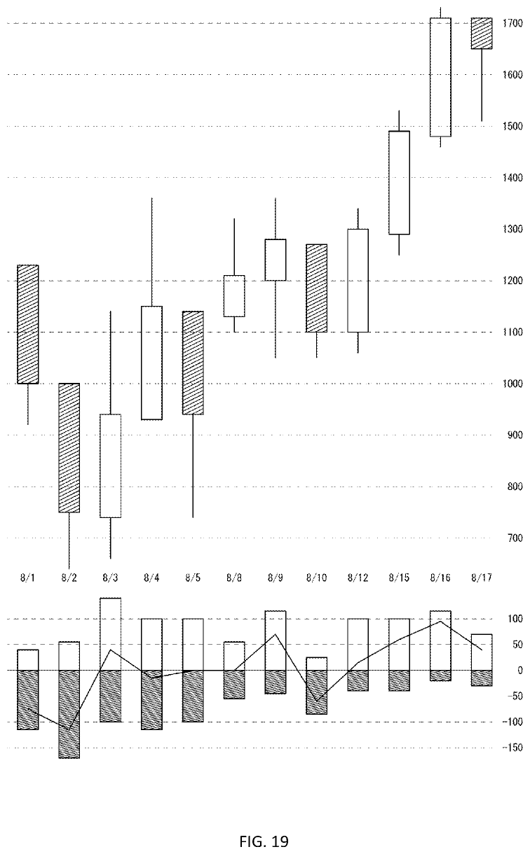

As shown in FIGS. 18 and 19, historical market displays based on the Candlestick method and the market display system 1 can also be displayed side by side. FIG. 18 provides an example where Candlestick lines are shown with a line graph representing the positive quantity P, the negative quantity N, and the mid-value M below. FIG. 19 provides an example where Candlestick lines are shown with a bar graph representing the positive quantity P, and the negative quantity N, and a line graph representing the mid-value M below. In this case, the periods (dates, times, etc.) of the two displays can be synchronized. In the illustrated example, the periods from 8/1 to 8/17 are depicted. Similar to the market display based on the Candlestick method, the market display system 1 can display positive and negative quantities for any period, such as minute, daily, or weekly intervals. It can be arranged not only vertically but also horizontally or in other configurations for simultaneous display.

The market display can be displayed side by side and can also be configured to be shown or hidden by the operator.

### Calculation of Positive Accumulation and Negative Accumulation

As shown in FIGS. 15 and 16, it is also possible to calculate the absolute value of the sum of the positive quantity P and the midpoint value M of stock price as positive force PF, and the absolute value of the sum of the negative quantity N and the mid-value M as negative force NF. For example, in period 2 (row 2), the positive quantity P is 55, the negative quantity N is −170, and the mid-value M is −115. Therefore, the positive force PF is calculated as 60 (=155+115)|), and the negative force NF is calculated as 285 (=|−170+115)|). Similarly, in period 9 (row 9), the positive quantity P is 100, the negative quantity N is −85, and the mid-value M is 15. Therefore, the positive force PF is calculated as 115 (=|100+15|), and the negative force NF is calculated as 70 (=|−85+15|).

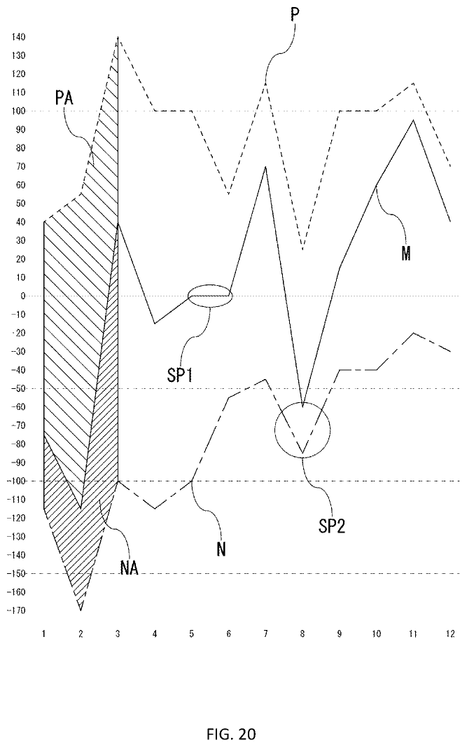

Furthermore, as shown in FIGS. 15 and 20, it is also possible to add up the positive forces PF and the negative forces NF of multiple periods to calculate the positive accumulation PA and the negative accumulation NA. If depicted in a chart, the shaded area above the midpoint value M on the line graph represents the positive accumulation PA, and the shaded area below the midpoint value M represents the negative accumulation NA. In the example graph, for periods 1-3, the positive forces PF and negative forces NF are respectively totaled to depict the positive accumulation PA and the negative accumulation NA. For example, in periods 4-6 (rows 4-6), the positive accumulation PA is calculated as 240 (=85+100+55), and the negative accumulation NA is calculated as 285 (=130+100+55).

In other words, it is possible to calculate the positive-negative ratio over a certain period as a basis for predicting future market trends. It can also be implemented using computers as a basis for buying and selling decisions.

### Specific Points

It is also possible to identify points that match specific conditions.

At the first specific point, SP1, shown in FIG. 20, the midpoint value, M, is 0. This indicates a balance between the positive quantity, P, and the negative quantity, N. At the second specific point, SP2, the mid-value, M, is extremely close to the negative quantity, N. This indicates a strong downward market trend.

Based on experience, after these specific points, the market tends to rise. For example, as anticipated at SP2, the market declines and then rises, so it can be a good time to buy stocks.

It is possible to set notifications for the end user, B, when these specific points are detected, i.e., for SP1, when the midpoint value, M, becomes 0 (or within a permissible range including 0), or for SP2, when the difference between the midpoint value, M, and the negative stock price quantity, N, is within a predetermined threshold. Additionally, automatic trading can be set to occur upon detection. Automated trading scenarios involve the securities company, C, acting as the market display administrator, A, and operating and utilizing this system.

### Processing Flow

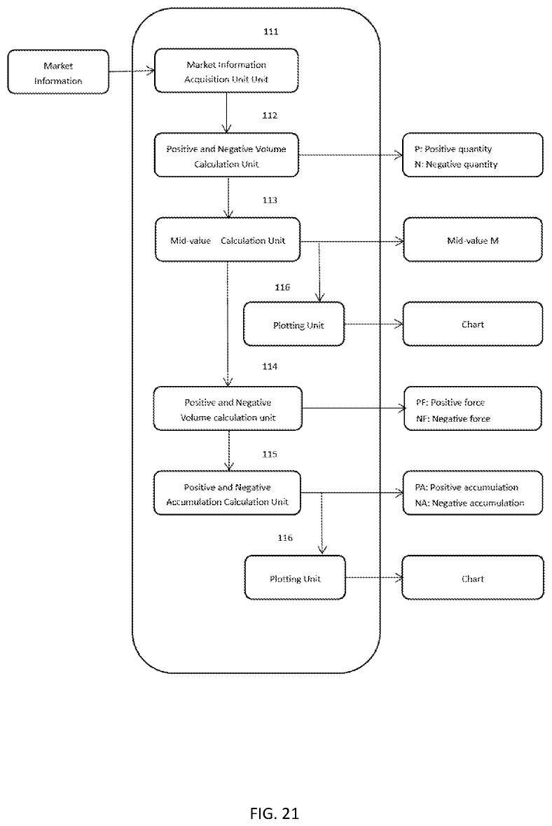

FIG. 21 is a flowchart representing the processing flow of the system. The central box represents the system's processing, the left side represents input information, and the right side represents information output by the system.

The opening price, the closing price, the lowest price, and the highest price are input into the market display system 1 as market information. Based on the input market information, the calculation unit 112 calculates the positive quantity, P, and the negative quantity, N. The mid-value, M, is calculated by the mid-value calculation unit 113 using the positive quantity, P, and the negative quantity, N. The positive force, PF, and the negative force, NF, are calculated by the positive and negative force calculation unit 114 based on the positive quantity, P, the negative quantity, N, and the mid-value, M. The positive accumulation, PA, and the negative accumulation, NA, are calculated by the positive and negative accumulation calculation unit 115 based on the positive force, PF, and the negative force, NF. The plotting unit 116 represents the calculated results in tables or charts.

Although the example provided focuses on stock trading, this system can also be used for foreign exchange (FX) and futures trading. In other words, as long as the values keep changing, the system can provide market displays for all types of data.

Furthermore, based on the same technological concept, the present invention also provides a market display analysis device comprising at least one processor and at least one memory for storing executable instructions for the processor. The specific connection medium between the processor and memory is not limited in the embodiments of this application, and they are connected via a bus. The bus can be divided into address bus, data bus, control bus, etc.

The processor serves as the control center of the electronic device and can be a general-purpose processor such as a central processing unit (CPU), a digital signal processor, an application-specific integrated circuit, a field-programmable gate array, or other programmable logic devices, discrete gates or transistor logic devices, discrete hardware components, etc. It can implement or execute the embodiments described herein, i.e., connect various parts of the electronic device using various interfaces and lines, and perform or execute instructions stored in the memory and call data stored in the memory to execute the market display analysis method described above.

The present invention also provides a computer-readable medium storing computer programs that can be executed by an electronic device. When the program is running on a terminal device, the computer program instructions are processed and executed to implement the market display analysis method described above.

Computer program instructions can also be stored in computer-readable storage media that can boot a computer or other programmable data processing device to operate in a specific manner, so that the instructions stored in the computer-readable storage media produce a manufactured product including an instruction device, which implements the functions specified in a flowchart or multiple flowcharts and/or a block diagram or multiple block diagrams.

Computer program instructions can also be loaded onto a computer or other programmable data processing device to perform a series of operations to generate computer-implemented processing, thereby providing steps for implementing the functions specified in a flowchart or multiple flowcharts and/or a block diagram or multiple block diagrams executed on a computer or other programmable device.

### INDUSTRIAL APPLICABILITY

The market display system of the present invention provides users with intuitive and easily understandable market displays. This can assist users in making judgments or automatically trading when buying or selling stocks or other securities.

What is claimed is:

1. A market display analysis method, comprising the steps of:
S1 obtaining an opening price, a closing price, a highest price, and a lowest price of a stock within a plurality of predetermined period;
S2 calculating the difference between the lowest price and the closing price as a positive quantity P, the difference between the highest price and the closing price as a negative quantity N, and the difference between the positive quantity P and the negative quantity N as a mid-value M within each of the plurality of predetermined period;
S3 plotting a line chart or a bar chart of the positive quantity P, the negative quantity N, and the median value M within each of the plurality of predetermined periods; and
S4 identifying a specific point SP on the line chart or the bar chart, and issuing a notification, an early warning, or a decision.

2. The market display analysis method according to claim 1, wherein step S2 further comprises the step of calculating the absolute value of the sum of the positive quantity P and the mid-value M as a positive force PF, and the absolute value of the sum of the negative quantity N and the mid-value M as a negative force NF within each of the plurality of predetermined period.

3. The market display analysis method according to claim 2, wherein the positive force PF and the negative force NF are added to calculate a positive accumulation PA, and a negative accumulation NA within each of the plurality of predetermined period.

4. The market display analysis method according to claim 3, wherein a line chart or a bar chart of the positive accumulation PA, and of the negative volume NA are plotted within each of the plurality of predetermined period.

5. The market display analysis method according to claim 1, wherein step S3 further comprises the step of plotting the market display according to a candlestick charting method side by side with the line chart or the bar chart.

6. The market display analysis method according to claim 1, wherein the specific point SP is one of: (a) when the mid-value M is zero, and (b) when the difference between the mid-value M and the negative quantity N is within a predetermined threshold.

7. A market display analysis system, comprising:
a market information acquisition unit for obtaining an opening price, a closing price, a highest price, and a lowest price within a plurality of predetermined period;
a processing unit for calculating the difference between the lowest price and the closing price as a positive quantity P, the difference between the highest price and the closing price as a negative quantity N, and the difference between the positive quantity P and the negative quantity N as a mid-value M within each of the plurality of predetermined period;
a plotting unit, for plotting a line chart or a bar chart of the positive quantity P, the negative quantity N, and the mid-value M within each of the plurality of predetermined period; and
an analysis unit for identifying a specific point SP on the line chart or the bar chart, and for issuing a notification, an early warning, or a decision.

8. The market display analysis system according to claim 7, wherein the processing unit further comprises a positive and negative quantity calculation unit, for calculating the difference between the lowest price and the closing price in as the positive quantity P, and the difference between the highest price and the closing price as the negative quantity N within each of the plurality of predetermined period, and the positive quantity P and the negative quantify N are plotted by the plotting unit.

9. The market display analysis system according to claim 7, wherein the processing unit further comprises a mid-value calculation unit, for calculating the mid-value M obtained by subtracting the positive quantity P from the negative quantity N within each of the plurality of predetermined period, and the mid-value is plotted by the plotting unit.

10. The market display analysis system according to claim 7, wherein the processing unit further comprises a positive and negative force calculation unit, for calculating absolute value of the sum of the positive quantity P and the mid-value M as a positive force PF, and the absolute value of the sum of the negative quantity N and the mid-value M as a negative force NF within each of the plurality of predetermined period, and the positive force PF and the negative force NF are plotted by the plotting unit.

11. The market display analysis system according to claim 7, wherein the processing unit further comprises a positive and negative accumulative calculation unit, for calculating a positive accumulative PA by adding positive forces PF, and a negative accumulation NA by adding the negative forces NF within each of the plurality of predetermined period, and the positive accumulative PA and the negative accumulation NA are plotted by the plotting unit.

12. The market display analysis system according to claim 7, wherein the plotting unit displays the positive quantity P, the negative quantity N, and the mid-value M within each of the plurality of predetermined period side by side with the candlestick chart method of stock prices.

13. The market display analysis system according to claim 7, further comprises a storage unit, wherein the storage unit includes:
a market information storage unit for storing information obtained by the market information acquisition unit, and/or
a calculation value storage unit for storing numerical value calculated by the processing unit.

14. The market display analysis system according to claim 7, wherein the specific point SP is one of: (a) when the mid-value M is zero, and (b) when the difference between the mid-value M and the negative quantity N is within a predetermined threshold.

15. A market display analysis device, comprising a processor and a memory, wherein the processor is used to execute a market display analysis program stored in the memory, in order to display the method according to claim 1.

16. A storage medium, wherein the storage medium stores one or more programs, and the one or more programs can be executed by one or more processors to implement the method according to claim 1.
